(19) United States
(12) Patent Application Publication
(10) Pub. No.: US 2025/0054678 A1
(43) Pub. Date: Feb. 13, 2025

(54) COIL DEVICE

(71) Applicant: TDK Corporation, Tokyo (JP)

(72) Inventors: Masayuki NAGATA, Tokyo (JP); Toshiyuki HORIKAWA, Tokyo (JP); Masaaki IWAKURA, Tokyo (JP); Tomohiro FURUICHI, Tokyo (JP); Kaito TANIZAKI, Tokyo (JP)

(73) Assignee: TDK Corporation, Tokyo (JP)

(21) Appl. No.: 18/925,546

(22) Filed: Oct. 24, 2024

(30) Foreign Application Priority Data
Nov. 1, 2023 (JP) 2023-187985

(51) Int. Cl. H01F 27/26; H01F 27/22; H01F 27/28; H01F 27/29

(52) U.S. Cl. CPC H01F 27/26; H01F 27/22; H01F 27/2828; H01F 27/29

(57) ABSTRACT

A coil device has a core including a magnetic material and a wire disposed in a coil shape around at least a part of the core. 70% or more of a volume of a middle leg portion of the core is located below an atmosphere open surface of a heat dissipation resin. An outer division gap of the core is provided in a middle or an end portion of the outer leg portion, and a partial adhesive portion in which an adhesive is interposed and an air layer in which an adhesive is not interposed are provided in the outer division gap.

### BACKGROUND OF THE INVENTION

### 1. Technical Field

The present invention relates to a coil device that can be suitably used as, for example, a transformer.

### 2. Description of the Related Art

In order to improve heat resistance of a coil device, for example, in JP 2014-36194 A, a part of a core is immersed in a heat dissipation resin to enhance a cooling effect. However, this technique has a problem that a portion covered with the heat dissipation resin is small, and a sufficient heat dissipation effect cannot be expected.

Therefore, it is conceivable that most of the core is covered with the heat dissipation resin, but when such a configuration is adopted, a case for storing the heat dissipation resin becomes too large, and this goes against demand for miniaturization of the coil device. Therefore, it is conceivable to cover with the heat dissipation resin so that a wound portion of a wire is immersed in a minimum necessary range.

Conventionally, a distal end of an outer leg portion of the core disposed outside a middle leg portion of the core in which the wound portion of the wire is disposed is generally entirely adhered to a distal end of another outer leg portion with an adhesive. Since a temperature of a heat dissipation resin located inside the outer leg portion of the core is higher than a temperature of a heat dissipation resin located outside the outer leg portion, stress may concentrate on a root portion between the outer leg portion and a base portion due to thermal expansion of the heat dissipation resin located inside the outer leg portion. When the concentration of stress increases, cracks and the like tend to easily occur in the core. In particular, with an increase in current of the coil device in recent years, reduction of thermal stress generated in the core has been a problem.

### CITATION LIST

### Patent Literature

Patent Literature 1: JP 2014-36194 A

### SUMMARY OF THE INVENTION

The present invention has been made in view of such circumstances, and an object thereof is to provide a coil device capable of reducing thermal stress generated in a core.

In order to achieve the above object, a coil device according to a first aspect of the present invention includes:
a core including a magnetic material; and
a wire disposed in a coil shape around at least a part of the core, in which the core includes:
a middle leg portion on which a wound portion of the wire is disposed,
outer leg portions disposed outside the wound portion of the wire, and
a base portion magnetically connecting the middle leg portion and the outer leg portions,
70% or more of a volume of the middle leg portion is located below an atmosphere open surface of a heat dissipation resin,
an outer division gap is provided in a middle or an end portion of the outer leg portion,
the outer division gap includes a partial adhesive portion in which an adhesive is interposed and an air layer in which an adhesive is not interposed, and
the air layer is located below the atmosphere open surface of the heat dissipation resin.

In this coil device, since most of the volume of the middle leg portion is located below the atmosphere open surface of the heat dissipation resin, most of a volume of the wound portion of the wire disposed around the middle leg portion is cooled by the heat dissipation resin together with the middle leg portion, and heat dissipation is improved. In addition, since the partial adhesive portion is provided in the middle or the end portion of the outer leg portion, it is easy to assemble and handle divided cores in which the wound portion of the wire is incorporated, and it is easy to manufacture the coil device.

In addition, since the outer division gap having the air layer is formed in the middle or the end portion of the outer leg portion, thermal expansion of the heat dissipation resin located inside the outer leg portion is easily absorbed by the middle portion or the end portion of the outer leg portion in which the division gap is formed. That is, the outer leg portion is easily deformed by the air layer in the division gap, and it is possible to suppress concentration of thermal stress on a specific part of the core. As a result, it is possible to reduce stress concentration that may occur at the root portion between the outer leg portion of the core and the base portion, and it is possible to suppress occurrence of cracks and the like.

In addition, since the outer leg portion has the adhesive portion, the coupling portion of the divided cores (coupling between the outer leg portions or coupling between the outer leg portion and the base portion) is less likely to deviate, and losses can be prevented from being increased. Furthermore, since the outer leg portion has the adhesive portion, it is possible to form an inner division gap (gap) that does not need to be adhered in the middle leg portion, and it is possible to freely adjust a gap width. A leakage property of the coil device can be adjusted by adjusting the gap width. Note that the middle leg portion may be provided with an adhesive portion, or may be provided with a butting portion not using an adhesive (a portion where the divided cores are only in contact with each other).

The outer leg portion may have a first outer leg portion and a second outer leg portion, and the outer division gap may be provided between a distal end of the first outer leg portion and a distal end of the second outer leg portion. The outer division gap may be provided between one end of the outer leg portion and an inner surface of the base portion.

An area proportion of the partial adhesive portion in a cross-section of the outer division gap is preferably 3% or more and 50% or less, 5% or more and 45% or less, 10% or more and 40% or less, or 15% or more and 35% or less. As the area proportion of the partial adhesive portion increases, adhesion between the outer leg portions or adhesion between the outer leg portion and the base portion tends to improve. In addition, as the area proportion of the partial adhesive portion decreases, an area proportion of the air layer relatively increases, and tendency of alleviating concentration of thermal stress increases.

A coil device according to a second aspect of the present invention includes:
a core including a magnetic material; and
a wire disposed in a coil shape around at least a part of the core, in which the core includes:
a middle leg portion on which a wound portion of the wire is disposed,
outer leg portions disposed outside the wound portion of the wire, and
a base portion magnetically connecting the middle leg portion and the outer leg portions,
70% or more of a volume of the middle leg portion is located below an atmosphere open surface of a heat dissipation resin,
an inner division gap is provided in a middle or an end portion of the middle leg portion,
the inner division gap includes an adhesive portion at least partially filled with an adhesive,
an outer division gap is provided in a middle or an end portion of the outer leg portion,
an air layer is provided in the outer division gap, and
the adhesive portion and the air layer are located below the atmosphere open surface of the heat dissipation resin.

In this coil device, since most of the volume of the middle leg portion is located below the atmosphere open surface of the heat dissipation resin, most of a volume of the wound portion of the wire disposed around the middle leg portion is cooled by the heat dissipation resin together with the middle leg portion, and heat dissipation is improved. In addition, since the adhesive portion is provided in the middle or the end portion of the middle leg portion, it is easy to assemble and handle divided cores in which the wound portion of the wire is incorporated, and it is easy to manufacture the coil device.

In addition, since the outer division gap having the air layer is formed in the middle or the end portion of the outer leg portion, thermal expansion of the heat dissipation resin located inside the outer leg portion is easily absorbed by the middle portion or the end portion of the outer leg portion in which the division gap is formed. That is, the outer leg portion is easily deformed by the air layer in the division gap, and it is possible to suppress concentration of thermal stress on a specific part of the core. As a result, it is possible to reduce stress concentration that may occur at the root portion between the outer leg portion of the core and the base portion, and it is possible to suppress occurrence of cracks and the like.

In addition, since the middle leg portion has the adhesive portion, it is not necessary to provide the adhesive portion in the outer leg portion, and the outer division gap having the air layer is easily formed in the middle or the end portion of the outer leg portion. An area proportion of the air layer in the cross-section of the outer division gap is preferably 50% or more, 60% or more, 70% or more, 80% or more, 90% or more, 95% or more, or 98% or more. As the area proportion of the air layer increases, the tendency of alleviating the concentration of thermal stress increases. In the outer division gap in which the air layer is not formed, an adhesive portion may be formed, a heat dissipation resin may enter, and a butting portion (a portion where the divided cores are only in contact with each other) in which the adhesive or the resin is not interposed may exist.

The middle leg portion may have a first middle leg portion and a second middle leg portion, and the inner division gap may be provided between a distal end of the first middle leg portion and a distal end of the second middle leg portion. The inner division gap may be provided between one end of the middle leg portion and an inner surface of the base portion.

Preferably, a gap width of the outer division gap is a thickness that does not allow the heat dissipation resin existing around the outer division gap to enter. An upper limit of the gap width is preferably 50 μm or less, 40 μm or less, 30 μm or less, or 20 μm or less. A lower limit of the gap width is preferably 5 μm or more, 8 μm or more, or 10 μm or more. The larger the gap width, the larger the stress alleviation effect tends to be, and the smaller the gap width, the easier the air layer tends to be formed.

The base portion may be close to a cooling wall surface of a case filled with the heat dissipation resin. When the cooling wall surface of the case is a bottom surface of the case, the core is preferably accommodated inside the case such that an axis of the wound portion of the wire is substantially perpendicular to the bottom surface of the case. When the cooling wall surface of the case is a side surface of the case, the core may be accommodated inside the case such that the axis of the wound portion of the wire is substantially parallel to the bottom surface of the case. With this configuration, heat dissipation of the middle leg portion and the wound portion of the wire disposed around the middle leg portion is improved.

Preferably, the heat dissipation resin is disposed at a position covering the wound portion of the wire disposed around the middle leg portion. With such a configuration, heat dissipation is improved.

The coil device may further have a terminal block that holds a lead portion of the wire. The terminal block may be mounted on a bobbin or may be mounted on a case that accommodates the heat dissipation resin. Alternatively, the terminal block may be mounted to the core.

### BRIEF DESCRIPTION OF THE DRAWINGS

FIG. 1 is a schematic perspective view of a coil device according to an embodiment of the present invention;

FIG. 2 is a schematic exploded perspective view of the coil device illustrated in FIG. 1;

FIG. 3A is a schematic cross-sectional perspective view taken along line IIIA-IIIA in FIG. 1;

FIG. 3B is a schematic cross-sectional view of a core taken along line IIIB-IIIB in FIG. 3A;

FIG. 4A1 is a cross-sectional view schematically illustrating only a core, a case, and a heat dissipation resin illustrated in FIG. 3A;

FIG. 4A2 is a schematic cross-sectional view exaggeratedly illustrating thermal deformation of the core in a case where a temperature difference occurs in the heat dissipation resin around the core illustrated in FIG. 4A1;

FIG. 4B1 is a cross-sectional view schematically illustrating a modification of the core illustrated in FIG. 4A1;

FIG. 4B2 is a schematic cross-sectional view exaggeratedly illustrating thermal deformation of the core in a case where a temperature difference occurs in the heat dissipation resin around the core illustrated in FIG. 4B1;

FIG. 4C is a schematic cross-sectional view according to another modification of the core illustrated in FIG. 4A1;

FIG. 4D is a schematic cross-sectional view according to still another modification of the core illustrated in FIG. 4A1;

FIG. 4E is a schematic cross-sectional view according to still another modification of the core illustrated in FIG. 4A1;

FIG. 4F is a schematic cross-sectional view according to another modification of the core illustrated in FIG. 4A1;

FIG. 4G is a schematic cross-sectional view according to still another modification of the core illustrated in FIG. 4A1; and

FIG. 4H is a schematic cross-sectional view according to still another modification of the core illustrated in FIG. 4B1.

### DETAILED DESCRIPTION

Hereinafter, embodiments of the present invention will be described with reference to the drawings. Note that the illustrated contents are merely schematic and exemplary for understanding the present invention, and the appearance, the dimensional ratio, and the like may be different from the actual ones. Further, the present invention is not limited to the following embodiments.

### First Embodiment

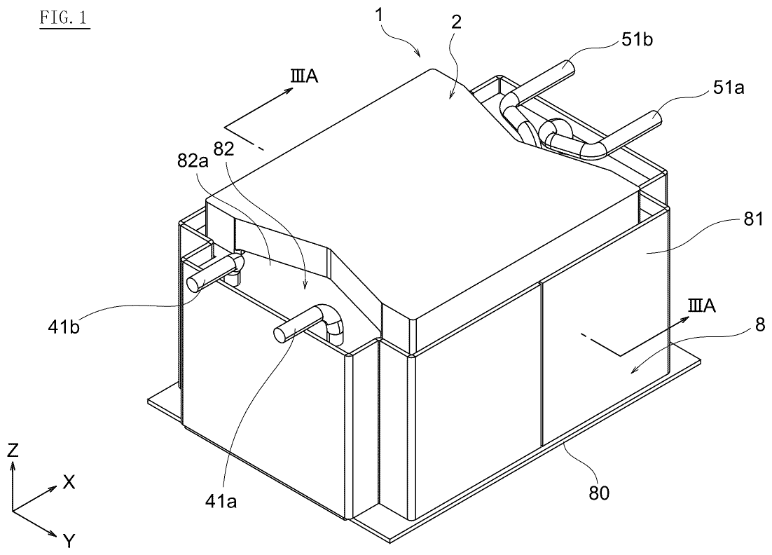

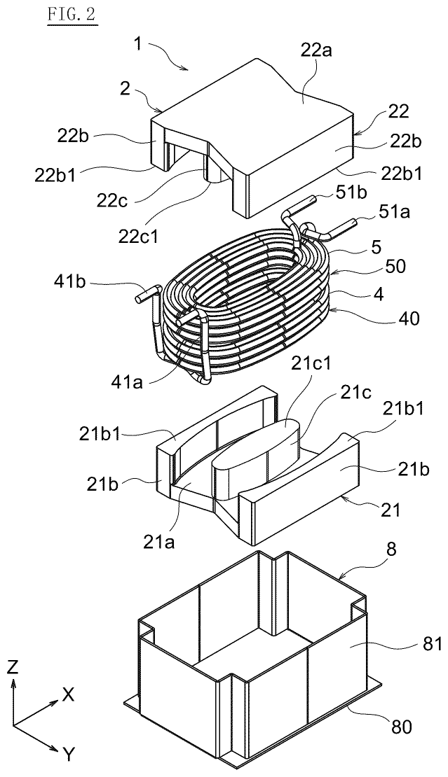

A coil device 1 according to an embodiment of the present invention illustrated in FIG. 1 functions as, for example, a leakage transformer, and is used for a vehicle-mounted charger, a power supply circuit of various electric devices, and the like. As illustrated in FIG. 2, the coil device 1 has a core 2, a wound portion 40 of a wire 4, a wound portion 50 of a wire 5, and a case 8.

In the drawings, an X-axis, a Y-axis, and a Z-axis are perpendicular to each other, and the Z-axis is parallel to a height direction of the coil device 1. Hereinafter, for each of the X-axis, the Y-axis, and the Z-axis, a direction toward a center of the coil device 1 is referred to as an inner side, and a direction away from the center of the coil device 1 is referred to as an outer side.

As illustrated in FIG. 2, in the present embodiment, the core 2 is configured by a combination of divided cores, and includes a first core 21 disposed on a lower side along the Z-axis, a second core 22 disposed on an upper side of the first core 21 along the Z-axis, and a middle leg portion 23 disposed between the first core 21 and the second core 22, which are pressed separately.

The first core 21 has a tabular first base portion 21a, outer leg portions 21b and 21b protruding upward along the Z-axis from both sides of the first base portion 21a along the Y-axis, and a middle leg portion 21c protruding upward along the Z-axis from a substantially center of the first base portion 21a along the Y-axis. In addition, the second core 22 has a tabular second base portion 22a, outer leg portions 22b and 22b protruding downward along the Z-axis from both sides of the second base portion 22a along the Y-axis, and a middle leg portion 22c protruding downward along the Z-axis from a substantially center of the second base portion 22a along the Y-axis.

In the present embodiment, the first core 21 and the second core 22 are respectively formed of E-shaped cores having a substantially E-shape in a cross-section parallel to a plane including the Z-axis and the Y-axis, and have the same shape, but may be different from each other. For example, one core may be an E-type core and the other core may be a U-type core. Each of the cores 21 and 22 is not particularly limited as long as it is a core having a magnetic material, and is made of, for example, ferrite, a metal magnetic material, or a magnetic powder-containing resin.

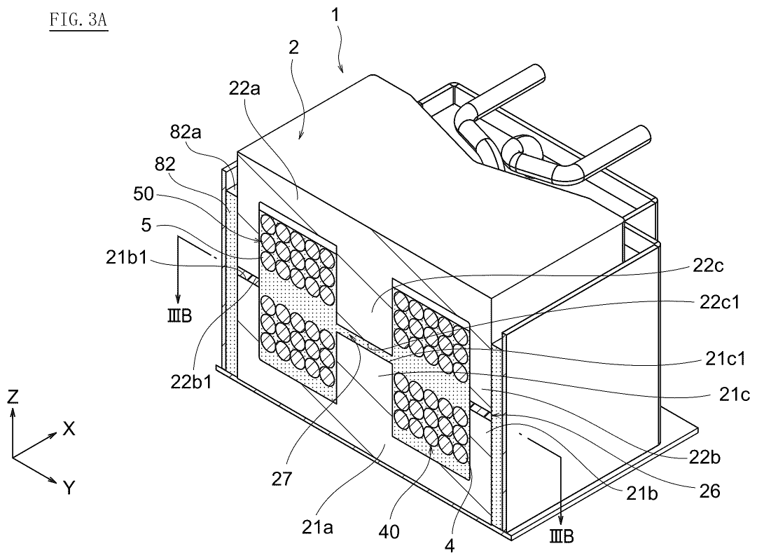

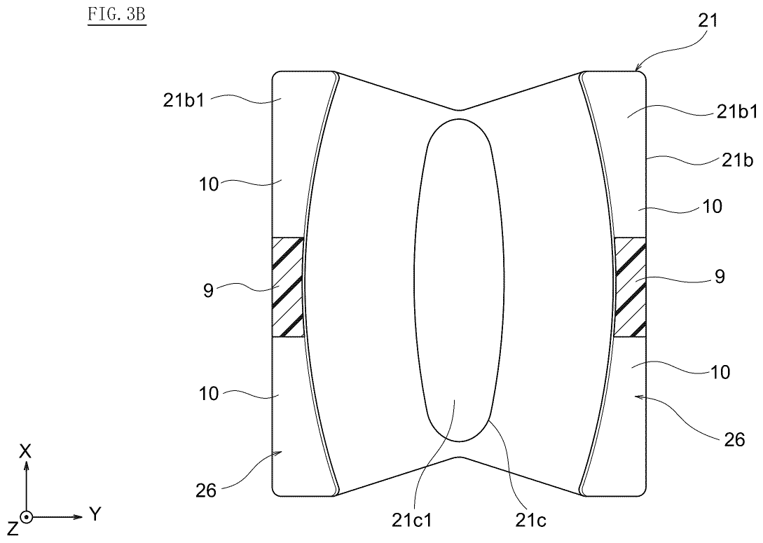

In the present embodiment, as illustrated in FIG. 3A, a first wire wound portion 40 around which the first wire 4 is wound is disposed around the middle leg portion 21c of the first core 21, and a second wire wound portion 50 around which the second wire 5 is wound is disposed around the middle leg portion 22c of the second core. In the present embodiment, the second wire wound portion 50 is disposed on an upper side of the first wire wound portion 40 along the Z-axis, but the disposition may be reversed. Further, for example, the first wire wound portion 40 serves as a primary coil of the transformer, and the second wire wound portion 50 serves as a secondary coil of the transformer, but may be reversed.

The first wire 4 and the second wire 5 may be directly wound around the middle leg portions 21c and 22c to form the first wire wound portion 40 and the second wire wound portion 50, respectively, but the first wire wound portion 40 and the second wire wound portion 50 may be prepared as air-core coils wound in advance and then disposed around the middle leg portions 21c and 22c. The outer leg portions 21b and 22b are disposed outside the wound portions 40 and 50 disposed around the middle leg portions 21c and 22c, respectively. The winding method of the wire 4 or 5 is not particularly limited, and examples thereof include normal winding and a-winding.

In the present embodiment, each of the first wire 4 and the second wire 5 is formed of a conductive wire, and may not be insulated and coated, but is preferably insulated and coated. A type of the conductive wire is not particularly limited, and is a conductive core wire such as a round wire, a rectangular wire, a stranded wire, a litz wire, or a braided wire. A material of a fusion layer or an insulating layer covering the core wire is not particularly limited, and examples thereof include polyurethane, polyamideimide, polyimide, and polyester.

In the present embodiment, both the first wire 4 and the second wire 5 are formed of a self-fusion type wire, but only one of the first wire 4 and the second wire 5 may be formed of a self-fusion type wire, or both of the first wire 4 and the second wire 5 may be formed of other wires. At least one of the first wire wound portion 40 and the second wire wound portion 50 may be a flat coil. Wire diameters of the first wire 4 and the second wire 5 may be the same or different, and are not particularly limited, but are preferably within a range of, for example, 1.0 to 3.0 mm.

As illustrated in FIG. 2, lead portions 41a and 41b are formed at both ends of the first wire 4 configuring the first wire wound portion 40, respectively, and the lead portions 41a and 41b are drawn upward from the first wound portion 40 along the Z-axis and coupled to terminals and the like (not illustrated). In addition, lead portions 51a and 51b are formed at both ends of the second wire 5 configuring the second wire wound portion 50, respectively, and the lead portions 51a and 51b are drawn upward from the second wound portion 50 along the Z-axis and coupled to terminals or the like, respectively.

Terminals to which the lead portions 41a, 41b, 51a, and 51b are coupled may be attached to, for example, a terminal block (not illustrated). The terminal block may be attached to an upper surface of the second core 22 of the core 2, or may be attached to the case 8, or may be attached to a bobbin (not illustrated).

As illustrated in FIG. 3A, the first core 21 to which the first wound portion 40 is attached and the second core 22 to which the second wound portion 50 is attached are assembled such that distal end portions 21cl and 22cl of the middle leg portions 21c and 22c face each other and distal end portions 21b1 and 22b1 of the outer leg portions 21b and 22b face each other.

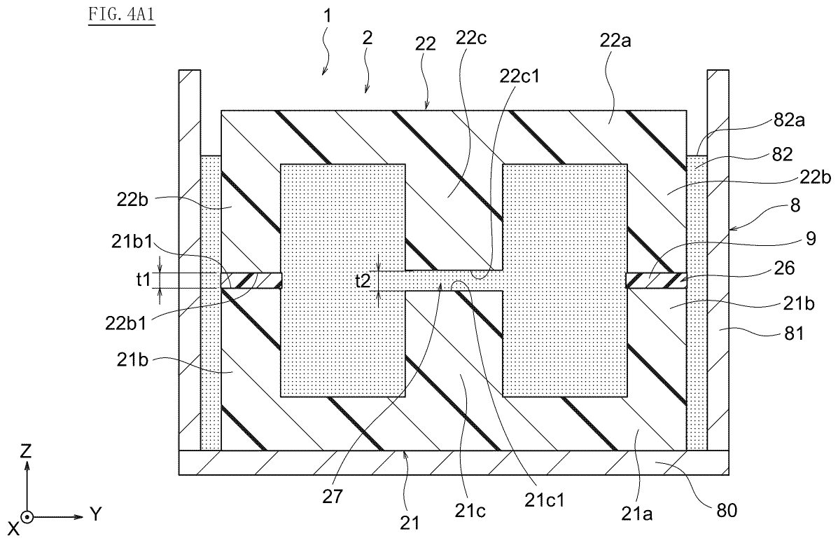

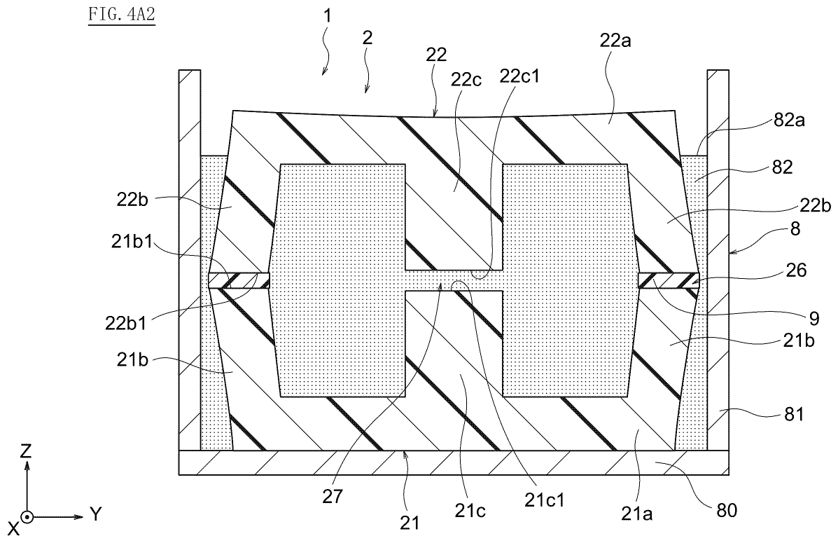

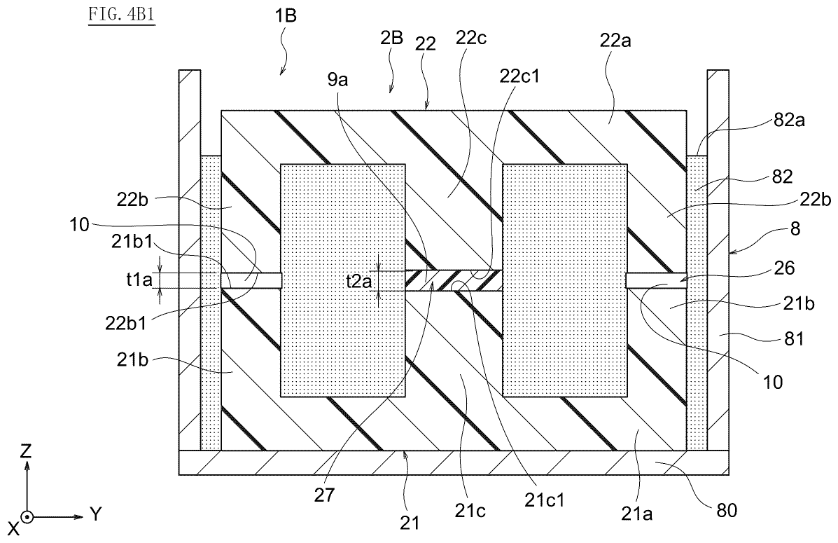

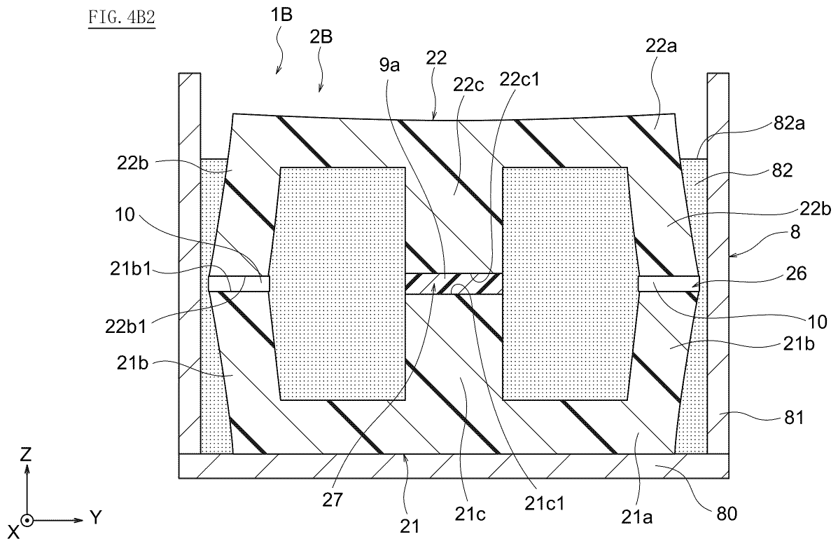

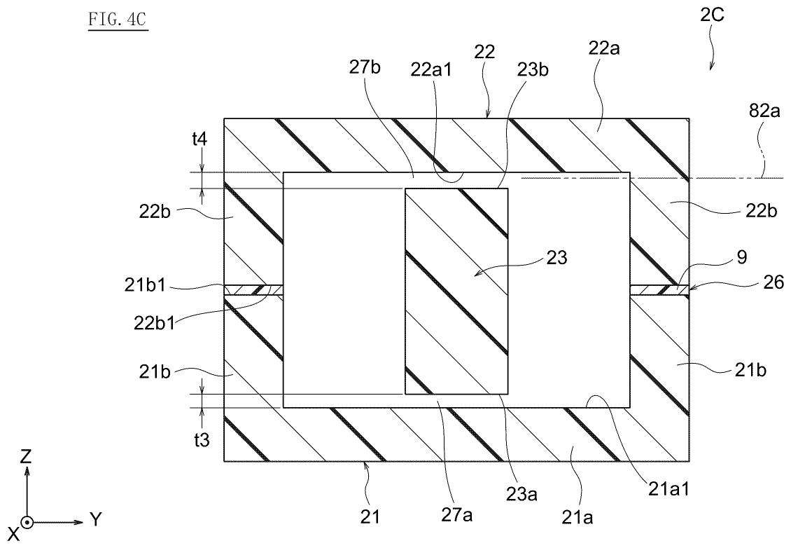

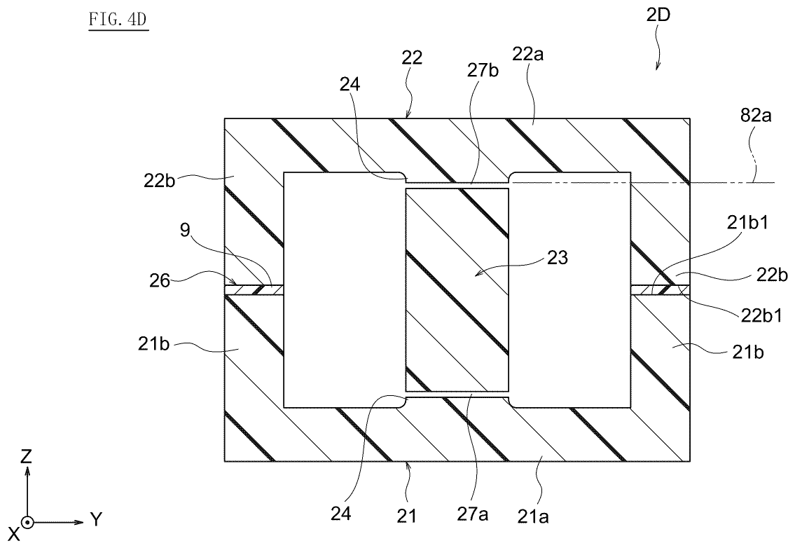

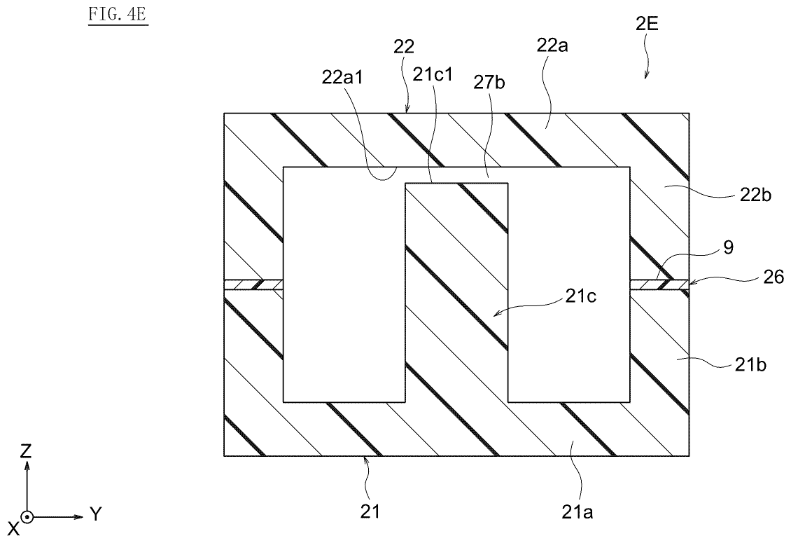

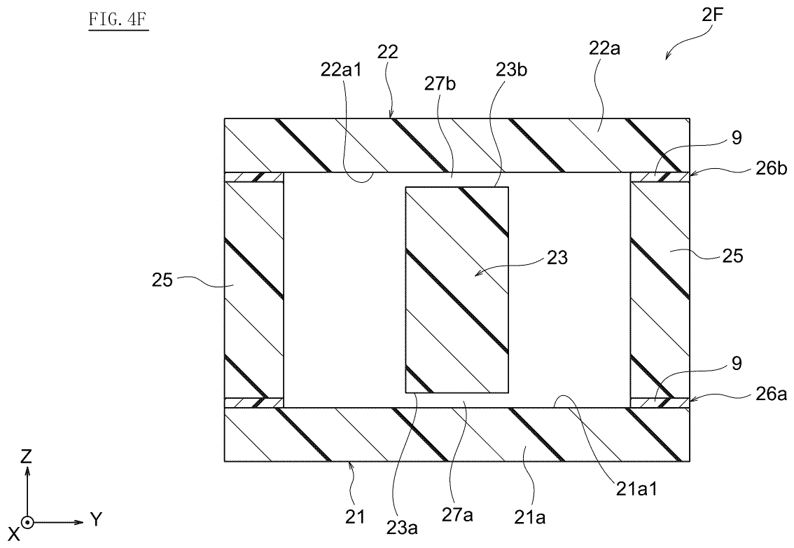

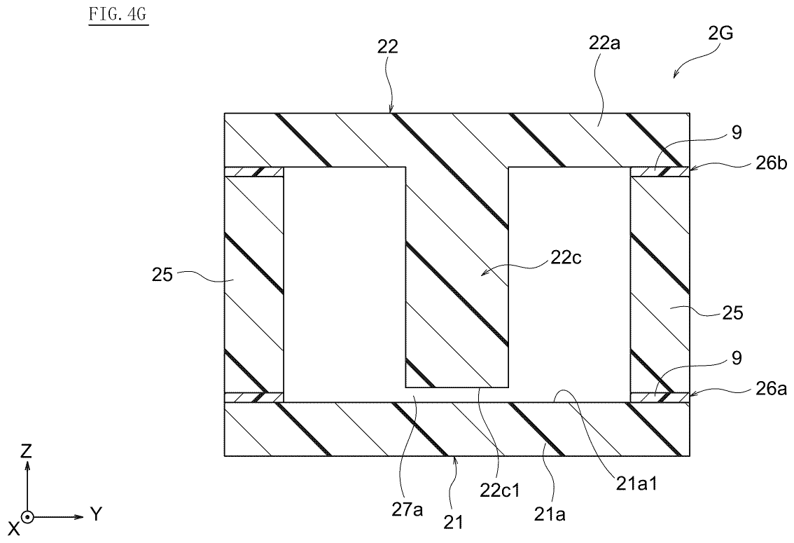

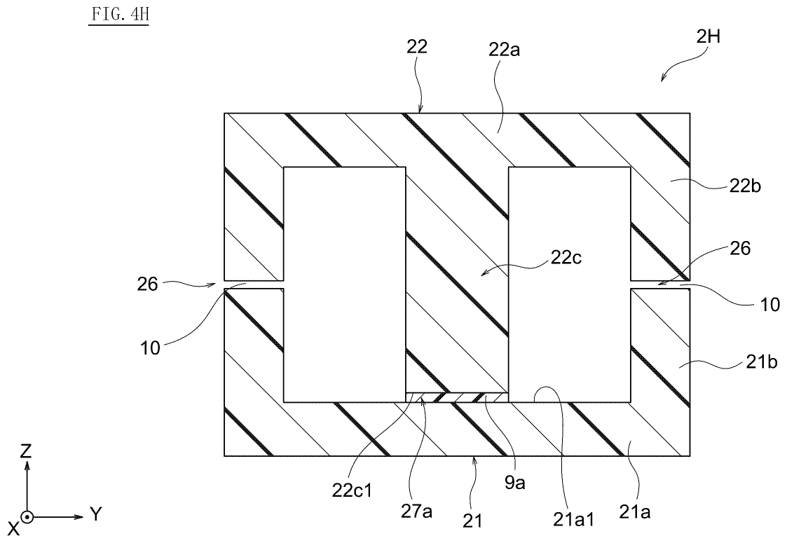

As illustrated in FIG. 4A1 in which illustration of the wound portions 40 and 50 illustrated in FIG. 3A is omitted, in the present embodiment, the distal end portions 21b1 and 22b1 of the outer leg portions 21b and 22b face each other at a predetermined interval (gap width) t1 along the Z-axis (winding axis of the wound portions 40 and 50 illustrated in FIG. 3A), and an outer division gap 26 of the core 2 is provided therebetween. In the present embodiment, the distal end portions 21c1 and 22c1 of the middle leg portions 21c and 22c face each other at a predetermined interval (gap width) t2 along the Z-axis (winding axis of the wound portions 40 and 50 illustrated in FIG. 3A), and an inner division gap 27 of the core 2 is provided therebetween. The division gaps 26 and 27 mean gaps at a butting portion (combination portion or joint portion) between the divided first core 21 and second core 22 configuring the core 2.

In the present embodiment, the inner division gap 27 having the predetermined interval t2 configures a gap in the core 2, and a heat dissipation resin 82 preferably enters the gap 27. However, the gap may be a gap to the extent that the heat dissipation resin 82 does not necessarily enter. Alternatively, the distal end portions 21c1 and 22c1 of the middle leg portions 21c and 22c may be in contact with each other so that the predetermined interval t2 becomes 0.

In the present embodiment, as illustrated in FIG. 3B, partial adhesive portions 9 are provided at substantially central positions along the X-axis in the outer division gaps 26 having the predetermined interval t1. In the partial adhesive portion 9, the adhesive is partially filled between the distal end portions 21b1 and 22b1 of the outer leg portions 21b and 22b illustrated in FIG. 4A1, and these distal end portions 21b1 and 22b1 are partially joined.

As illustrated in FIG. 3B, air layers 10 in which no adhesive exists are provided on both sides of each partial adhesive portion 9 along the X-axis. The air layer 10 is defined as a portion formed in the gap having the predetermined interval t1 provided between the distal end portions 21b1 and 22b1 of the outer leg portions 21b and 22b illustrated in FIG. 4A1. An adhesive is not interposed in the gap portion (air layer 10) having the predetermined interval t1, and the predetermined interval t1 is adjusted so that the heat dissipation resin 82 does not enter.

An upper limit of the predetermined interval (gap width) t1 is preferably 50 μm or less, 40 μm or less, 30 μm or less, or 20 μm or less. A lower limit of the predetermined interval t1 is preferably 5 μm or more, 8 μm or more, or 10 μm or more. The larger the predetermined interval t1, the larger the stress alleviation effect tends to be, and the smaller the gap width, the easier the air layer tends to be formed.

As illustrated in FIG. 3B, an area proportion of the partial adhesive portion 9 in the cross-section of the outer division gap 26 of the core is preferably 3% or more and 50% or less, 5% or more and 45% or less, 10% or more and 40% or less, or 15% or more and 35% or less with respect to an entire cross-section of the outer division gap 26. As the area proportion of the partial adhesive portion increases, adhesion between the outer leg portions or adhesion between the outer leg portion and the base portion tends to improve. In addition, as the area proportion of the partial adhesive portion decreases, an area proportion of the air layer relatively increases, and tendency of alleviating concentration of thermal stress increases. The entire cross-section of the outer division gap 26 is also an entire area of the distal end portions 21b1 and 22b1 of the outer leg portions 21b and 22b.

Further, in the present embodiment, it is preferable that the partial adhesive portions 9 are provided at the substantially center of the outer division gaps 26 along the X-axis, and the air layers 10 are provided on both sides of the partial adhesive portions 9 along the X-axis, but the present invention is not limited thereto. For example, the partial adhesive portions 9 may be provided at positions of the outer division gaps 26 along the X-axis, and the air layers 10 may be disposed therebetween. In the present embodiment, the partial adhesive portion 9 includes the distal end portions 21b1 and 22b1 of the outer leg portions 21b and 22b so as to be continuous along the Y-axis, but the partial adhesive portion 9 may intermittently include the distal end portions 21b1 and 22b1. Further, the air layer 10 may be provided on one side or both sides of the partial adhesive portion 9 along the Y-axis.

In the coil device 1, as illustrated in FIG. 4A1, most of volumes of the middle leg portions 21c and 22c are located below an atmosphere open surface 82a of the heat dissipation resin 82 (on the side of the heat dissipation resin 82). That is, the atmosphere open surface 82a is set such that 70% or more, preferably 80% or more, more preferably 90% or more, or 95% or more of the volumes of the middle leg portions 21c and 22c are located below the atmosphere open surface 82a of the heat dissipation resin 82.

As illustrated in FIG. 3A, the atmosphere open surface 82a of the heat dissipation resin 82 is determined such that the wound portion 50 of the second wire 5 is sufficiently immersed in the heat dissipation resin 82, and preferably 80% or more, more preferably 95% or more, or substantially 100% or more of the wound portion 40 of the first wire 4 is immersed in the heat dissipation resin 82. With such a configuration, heat generated in the wound portion 40 or 50 of the wire 4 or 5 is also cooled by the heat dissipation resin 82.

In the present embodiment, the heat transferred from the wound portion 40 or 50 of the wire 4 or 5 or the core 2 to the heat dissipation resin 82 is transferred to a cooling material (for example, a cooling block or the like with a cooling passage) installed on a lower surface of a bottom plate 80 of the case 8 through the case 8 and dissipated. The atmosphere open surface 82a is a surface in which a liquid level formed by pouring the heat dissipation resin 82 in a flowing state into the case 8 is solidified.

As illustrated in FIG. 1, the case 8 has the bottom plate 80 having a substantially rectangular shape, and side plates 81 rising upward from four side positions of the bottom plate 80 along the Z-axis and forming a bottomed accommodation space therein, and an upper opening portion is formed in an upper portion along the Z-axis. The case 8 is preferably made of a metal such as aluminum having excellent thermal conductivity, but may be made of a resin.

The heat dissipation resin 82 is also referred to as a potting resin, and is made of a silicone resin, a urethane resin, an epoxy resin, or the like that remains soft even after injection, and a longitudinal elastic modulus of the potting resin is preferably 0.1 to 100 MPa. In the present embodiment, for example, the heat generated in the first wound portion 40, the second wound portion 50, and the core 2 can be efficiently dissipated from the bottom portion of the case 8 to an outside via the heat dissipation resin 82 and the case 8, and cooling efficiency of the coil device 1 can be enhanced.

The heat dissipation resin 82 may accommodate the core 2 to which the wound portions 40 and 50 of the wires illustrated in FIG. 2 are attached after the inside of the case 8 is filled in advance, or the heat dissipation resin 82 may be flowed inside the case 8 after accommodating the core 2 to which the wound portions 40 and 50 of the wires are attached inside the case 8.

In the coil device 1 according to the present embodiment, as illustrated in FIGS. 3A and 4A1, since most of the volumes of the middle leg portions 21c and 22c of the core 2 are located below the atmosphere open surface 82a of the heat dissipation resin 82, most of the volumes of the wound portions 40 and 50 of the wires 4 and 5 disposed around the middle leg portions 21c and 22c are also cooled by the heat dissipation resin 82 together with the middle leg portions 21c and 22c, and heat dissipation is improved. That is, the atmosphere open surface 82a of the heat dissipation resin 82 is at a position where the heat dissipation resin 82 covers the wound portions 40 and 50 of the wires 4 and 5 disposed around the middle leg portion 23, so that the heat dissipation of the wound portions 40 and 50 is improved.

Moreover, in the present embodiment, since the partial adhesive portion 9 is provided in the middle of the outer leg portions 21b and 22b, that is, between the distal end portions 21b1 and 22b1 of the outer leg portions 21b and 22b together with the air layer 10, it is easy to assemble and handle the first core 21 and the second core 22 into which the wound portions 40 and 50 of the wires 4 and 5 are incorporated and divided, and it is easy to manufacture the coil device 1.

In addition, since the outer division gap 26 having the air layer 10 is formed in the middle of the outer leg portions 21b and 22b, thermal expansion of the heat dissipation resin 82 located inside the outer leg portions 21b and 22b is easily absorbed by the middle portion of the outer leg portions 21b and 22b where the division gap 26 is formed. That is, due to the air layer 10 in the division gap 26, as illustrated in FIG. 4A2, the outer leg portions 21b and 22b are easily deformed outward, and it is possible to suppress concentration of thermal stress on a specific part of the core 2. As a result, it is possible to reduce stress concentration that may occur at a root portion between the outer leg portion 22b and the base portion 22a of the core 2, particularly at an inner side of a connection portion between the outer leg portion 22b and the second base portion 22a, and it is possible to suppress occurrence of cracks and the like.

In addition, since the partial adhesive portion 9 is provided in the middle (between) of the outer leg portions 21b and 22b, the coupling portion (coupling between the outer leg portions 21b and 22b) of the divided cores is less likely to be deviated, and losses can be prevented from being increased. Note that in the coil device 1 of the present embodiment, in a case where there is no partial adhesive portion 9, the coupling portion (coupling between the outer leg portions 21b and 22b) of the divided cores is likely to deviate, and the losses tend to increase.

Furthermore, in the present embodiment, as illustrated in FIG. 4A1, since the partial adhesive portion 9 is provided between the outer leg portions 21b and 22b, it is possible to form the inner division gap (gap) 27 having the predetermined interval t2 that does not need to be adhered between the distal end portions 21c1 and 22c1 of the middle leg portions 21c and 22c, and it is possible to freely adjust the predetermined interval (gap width) t2. A leakage property of the coil device 1 can be adjusted by adjusting a gap width t2.

In the present embodiment, a lower limit of the predetermined interval t2 may be 0, and the distal end portions 21c1 and 22c1 of the middle leg portions 21c and 22c may butt against each other at the predetermined interval t2 of 0. Alternatively, the predetermined interval t2 may be, for example, 10 μm or more, 30 μm or more, 50 μm or more, or 60 μm or more. When the predetermined interval t2 is less than 50 μm, the heat dissipation resin 82 hardly enters the division gap 27, and an air layer is easily formed in the gap 27. When the predetermined interval t2 is 50 μm or more, the heat dissipation resin 82 tends to easily enter the gap 27. Note that in at least a part of the gap 27, an adhesive portion similar to the partial adhesive portion 9 may be formed, another resin or spacer may be interposed, or an air layer may be formed in at least a part thereof.

In the present embodiment, the first base portion 21a is close to the bottom plate 80 which is a cooling wall surface of the case 8 filled with the heat dissipation resin 82. When the cooling wall surface of the case 8 is a bottom surface of the case 8, the core 2 is preferably accommodated inside the case 8 such that the axis of the wound portions 40 and 50 of the wires 4 and 5 is substantially perpendicular to the bottom surface of the case 8.

In another embodiment, when the cooling wall surface of the case 8 is a side surface (side plate 81) of the case 8, the core 2 may be accommodated inside the case 8 such that the axis of the wound portions 40 and 50 of the wires 4 and 5 is substantially parallel to the bottom surface of the case 8.

### Second Embodiment

As illustrated in FIGS. 4B1 and 4B2, a coil device 1B of the present embodiment is similar to the coil device 1 of the above-described embodiment except for the following, and exhibits similar action and effect. That is, in a core 2B of the coil device 1B of the present embodiment, the inner division gap 27 of the core is provided in the middle of the middle leg portions 21c and 22c, that is, between the distal end portions 21c1 and 22c1 of the middle leg portions 21c and 22c. The inner division gap 27 is provided with an adhesive portion 9a at least partially filled with an adhesive. In addition, the outer division gap 26 of the core is provided in the middle of the outer leg portions 21b and 22b, that is, between the distal end portions 21b1 and 22b1 of the outer leg portions 21b and 22b. The air layer 10 is provided in the outer division gap 26, and the adhesive portion 9a and the air layer 10 are located below the atmosphere open surface 82a of the heat dissipation resin 82.

Also in this coil device 1B, since most of the volumes of the middle leg portions 21c and 22c are located below the atmosphere open surface 82a of the heat dissipation resin 82, most of the volumes of the wound portions 40 and 50 of the wires are cooled by the heat dissipation resin together with the middle leg portions 21c and 22c, and heat dissipation is improved. In addition, since the adhesive portion 9a is provided in the middle of the middle leg portions 21c and 22c, it is easy to assemble and handle the divided cores in which the wound portions 40 and 50 of the wires are incorporated, and it is easy to manufacture the coil device 1B.

In addition, since the outer division gap 26 having the air layer 10 is formed in the middle of the outer leg portions 21b and 22b, thermal expansion of the heat dissipation resin 82 located inside the outer leg portions 21b and 22b is easily absorbed by the middle portion of the outer leg portions 21b and 22b where the division gap 26 is formed. That is, as illustrated in FIG. 4B2, the outer leg portions 21b and 22b are easily deformed by the air layer 10 in the division gap 26, and it is possible to suppress concentration of thermal stress on a specific part of the core. As a result, it is possible to reduce stress concentration that may occur particularly at the root portion between the outer leg portion 22b and the base portion 22a of the core, and it is possible to suppress occurrence of cracks and the like.

In addition, since the middle leg portions 21c and 22c have the adhesive portion 9a, it is not necessary to provide an adhesive portion in the outer leg portions 21b and 22b, and the outer division gap 26 having the air layer 10 is easily formed in the middle of the outer leg portions 21b and 22b. The area proportion of the air layer 10 in the cross-section of the outer division gap 26 is preferably 50% or more, 60% or more, 70% or more, 80% or more, 90% or more, 95% or more, or 98% or more. As the area proportion of the air layer 10 increases, the tendency of alleviating the concentration of the thermal stress increases. In the outer division gap 26 in which the air layer 10 is not formed, an adhesive portion may be formed, the heat dissipation resin 82 may enter, and a butting portion (a portion where the divided cores are only in contact with each other) in which the adhesive or the resin is not interposed may exist.

In the present embodiment, a gap width t1a of the outer division gap 26 is preferably a thickness that does not allow the heat dissipation resin 82 existing around the outer division gap 26 to enter. An upper limit of the gap width t1a is preferably 50 μm or less, 40 μm or less, 30 μm or less, or 20 μm or less. A lower limit of the gap width t1a is preferably 5 μm or more, 8 μm or more, or 10 μm or more. The larger the gap width t1a, the larger the stress alleviation effect tends to be, and the smaller the gap width t1a, the easier the air layer tends to be formed.

In addition, a predetermined interval t2a of the inner division gap 27 included in the adhesive portion 9a may be a gap to the extent that the distal end portion 21c1 of the middle leg portion 21c and the distal end portion 22c1 of the middle leg portion 22c are joined by an adhesive, and may be, for example, 10 μm or more, 30 μm or more, 50 μm or more, or 60 μm or more.

### Third Embodiment

As illustrated in FIG. 4C, a coil device of the present embodiment is similar to the coil device 1 of the above-described first embodiment except for the following, and exhibits similar action and effect. That is, the coil device of the present embodiment has the same configuration except for having a core 2C different from the core 2 of the above-described embodiment, and exhibits similar action and effect.

In the core 2C of the present embodiment, unlike the core 2 of the above-described embodiment, one end (lower end) 23a of the single middle leg portion 23 is magnetically connected to an inner surface 21al of the base portion 21a of the first core 21 by a first inner division gap 27a having a predetermined interval t3. In addition, the other end (upper end) 23b of the middle leg portion 23 is magnetically connected to an inner surface 22al of the base portion 22a of the second core 22 by a second inner division gap 27a having a predetermined interval t4. The predetermined intervals t3 and t4 are not particularly limited, and for example, since a sum of the predetermined intervals t3 and t4 determines the leakage property or the like of the coil device and is therefore determined to be equivalent to the predetermined interval t2 illustrated in FIG. 4A1.

The core 2C of the present embodiment is similar to that of the first embodiment in that the outer division gap 26 having the partial adhesive portion 9 is provided in the middle of the outer leg portions 21b and 22b, and exhibits similar action and effect.

In the present embodiment, the atmosphere open surface 82a is set such that 70% or more, preferably 80% or more, more preferably 90% or more, or 95% or more of the volume of the middle leg portion 23 is located below the atmosphere open surface 82a of the heat dissipation resin 82, and is located below the inner surface 22al of the base portion 22a along the Z-axis. With this configuration, an air layer into which the heat dissipation resin 82 does not enter is formed in a gap 27b. The heat dissipation resin may or may not enter the gap 27a. For example, by setting the predetermined interval t3 to 50 μm or less, it becomes difficult for the heat dissipation resin to enter, and the air layer is easily formed.

In the present embodiment, when the air layer including the gap 27a is formed between the first base portion 21a and the one end (lower end 23a) of the middle leg portion 23, the heat of the middle leg portion 23 is less likely to be transferred to the first base portion 21a, and a change in temperature distribution of the middle leg portion 23 along a winding axis is reduced. The middle leg portion 23 is uniformly cooled by the heat dissipation resin. As a result, a rapid temperature gradient is hardly generated in the middle leg portion 23 along the winding axis (parallel to the Z-axis) of the wire 4 or 5, thermal stress generated in the core 2 (particularly, the middle leg portion 23) is reduced, and a core loss is reduced.

In the present embodiment, the gap 27b including an air layer of preferably 3 mm or less, more preferably 2 mm or less, and still more preferably 1.9 mm or less may be formed between the inner surface 22al of the second base portion 22a and the upper end 23b of the middle leg portion 23. Since the air layer exists between the second base portion 22a and the upper end 23b of the middle leg portion 23, stress such as a thermal expansion force generated in the middle leg portion 23 is less likely to be transferred to the second base portion 22a, and thermal stress that may be generated in the second base portion 22a can be reduced. As a result, it is possible to further reduce a risk of occurrence of inconvenience such as cracking or chipping of the core.

In the present embodiment, 30% or more, 50% or more, 80% or more, or 95% or more, preferably 100% or more of the volume of the second base portion 22a is exposed from the heat dissipation resin 82. By exposing most of the second base portion 22a, it is possible to reduce a size of the case 8 accommodating the heat dissipation resin 82 and to reduce an amount of the heat dissipation resin 82. Moreover, even in this case, since the second base portion 22a is disposed at the upper end of the middle leg portion 23 along the Z-axis so as to be separated by the gap 27b having a predetermined interval, stress such as a thermal expansion force generated in the middle leg portion 23 where heat is likely to clog is not transferred to the second base portion 22a.

In the present embodiment, the upper end 23b of the middle leg portion 23 may be located below the atmosphere open surface 82a of the heat dissipation resin 82. With such a configuration, heat dissipation of the middle leg portion 23 and the wound portions 40 and 50 of the wires 4 and 5 disposed around the middle leg portion 23 is improved. Even in this case, the position of the atmosphere open surface 82a may be located in the middle of the gap 27b so that an air layer is formed in the gap 27b. The upper end 23b of middle leg portion 23 may be located above the atmosphere open surface 82a of the heat dissipation resin 82.

### Fourth Embodiment

As illustrated in FIG. 4D, a coil device of the present embodiment is similar to the coil device of the above-described third embodiment except for the following, and exhibits similar action and effect. That is, the coil device of the present embodiment has the same configuration except for having a core 2D different from the core 2C of the above-described embodiment, and exhibits similar action and effect.

In the core 2D of the present embodiment, unlike the core 2C of the above-described embodiment, stepped protrusions 24 are formed on the inner surface of the base portion 21a facing the upper end or the lower end of the middle leg portion 23 along the Z-axis. A protruding height (along the Z-axis) of the stepped protrusion 24 is not particularly limited as long as the gap 27b or 27a is formed between a distal end of the stepped protrusion 24 along the Z-axis and the upper end or lower end of the middle leg portion 23.

However, the protruding height of the stepped protrusion 24 facing the upper end of the middle leg portion 23 is desirably as small as possible. Other configurations and action and effect are similar to those of the above-described embodiment, and the description of overlapping portions is omitted.

### Fifth Embodiment

As illustrated in FIG. 4E, a coil device of the present embodiment is similar to the coil device (see FIG. 4C) of the above-described third embodiment except for the following, and exhibits similar action and effect. That is, the coil device of the present embodiment has the same configuration except for having a core 2E different from the core 2C of the above-described embodiment, and exhibits similar action and effect.

In the core 2E of the present embodiment, the second core 22 is a core having a U-shaped cross-section, and the inner surface 22al of a substantially center of the second core 22 along the Y-axis and the distal end portion 21c1 of the middle leg portion 21c formed integrally with the base portion 21a of the first core 21 face each other with the inner gap 27b having a predetermined interval. In the present embodiment, the interval of the inner gap 27b along the Z-axis is about the sum of the predetermined intervals t3 and t4 illustrated in FIG. 4C.

### Sixth Embodiment

As illustrated in FIG. 4F, a coil device of the present embodiment is similar to the coil device (see FIG. 4C) of the above-described third embodiment except for the following, and exhibits similar action and effect. That is, the coil device of the present embodiment has the same configuration except for having a core 2F different from the core 2C of the above-described embodiment, and exhibits similar action and effect.

The core 2F of the present embodiment is different from the core 2C of the above-described embodiment in that the first core 21 has a first base portion 21a independent of outer leg portions 25, and the second core 22 has a second base portion 22a independent of the outer leg portions 25. The outer leg portion 25 has a configuration in which the outer leg portion 21b and the outer leg portion 22b facing each other along the Z-axis direction of the above-described embodiment are integrated, and separated and independent from the respective base portions 21a and 22a. In the present embodiment, a first outer division gap 26a having the partial adhesive portion 9 and the air layer 10 (see FIG. 3B) is provided at one end (lower end) of the outer leg portion 25, and a second outer division gap 26b having the partial adhesive portion 9 and the air layer 10 (see FIG. 3B) is provided at the other end (upper end) of the outer leg portion 25. Other configurations and action and effect are similar to those of the above-described embodiment, and the description of overlapping portions is omitted.

### Seventh Embodiment

As illustrated in FIG. 4G, a coil device of the present embodiment is similar to the coil device (FIG. 4F) of the above-described sixth embodiment except for the following, and exhibits similar action and effect. That is, the coil device of the present embodiment has the same configuration except for having a core 2G different from the core 2F of the above-described embodiment, and exhibits similar action and effect.

In the core 2G of the present embodiment, unlike the core 2F of the above-described embodiment, the upper end of the middle leg portion 22c is integrally pressed with the second base portion 22a of the second core 22. That is, the first core 21 is a core having a U-shaped cross-section, and the inner surface 21al of the substantially center of the first core 21 along the Y-axis and the distal end portion 22c1 of the middle leg portion 22c formed integrally with the base portion 22a of the second core 22 face each other with the inner gap 27a having a predetermined interval. In the present embodiment, the interval of the inner gap 27a along the Z-axis is about the sum of the predetermined intervals t3 and t4 illustrated in FIG. 4C. Other configurations and action and effect are similar to those of the above-described embodiment, and the description of overlapping portions is omitted.

### Eighth Embodiment

As illustrated in FIG. 4H, a coil device of the present embodiment is similar to the coil device 1B of the above-described second embodiment except for the following, and exhibits similar action and effect. That is, the coil device of the present embodiment has the same configuration except for having a core 2H different from the core 2B of the above-described embodiment, and exhibits similar action and effect.

In the core 2H of the present embodiment, unlike the core 2B of the above-described embodiment illustrated in FIG. 4B1, the distal end portion 22c1 of the middle leg portion 22c integrally formed in the second base portion 22a faces the inner surface 21al of the first base portion 21a of the first core 21 with the inner division gap 27a having a predetermined interval. In addition, the adhesive portion 9a is formed in the gap 27a, and it joins the distal end portion 22c1 of the middle leg portion 22c and the inner surface 21al of the first base portion 21a of the first core 21. Other configurations and action and effect are similar to those of the above-described embodiment, and the description of overlapping portions is omitted.

Note that the present invention is not limited to the above-described embodiments, and various modifications can be made within the scope of the present invention.

For example, in the embodiments described above, the core 2 is configured by combining two to four divided cores, but the core 2 is not limited to the number of divisions, and may be configured by a combination of cores of another number of divisions of five or more, for example.

In the present embodiment, the Z-axis is substantially parallel to the winding axis of the wire wound portion 40 or 50, but the winding axis of the wire wound portion 40 or 50 may be accommodated inside the case 8 so as to be substantially parallel to the X-axis or the Y-axis. Even in this case, the gaps 26 and 26a having the partial adhesive portion 9 or the gaps 27 and 27a having the adhesive portion 9a are preferably located below the atmosphere open surface 82a.

Furthermore, in the embodiments described above, the coil device without a tubular portion of a bobbin between the middle leg portions 21c, 22c, and 23 and the wound portions 40 and 50 of the wires 4 and 5 has been described, but the coil device of the present embodiment may be a coil device in which the tubular portion of the bobbin is disposed therebetween.

### REFERENCE SIGNS LIST

1, 1B Coil device
2, 2B to 2H Core
21 First core
21a First base portion
21a1 Inner surface
21b Outer leg portion
21b1 Distal end portion
21c Middle leg portion
21c1 Distal end portion
22 Second core
22a Second base portion
22a1 Inner surface
22b Outer leg portion
22b1 Distal end portion
22 Middle leg portion
22c1 Distal end portion
23 Middle leg portion
23a Lower end
23b Upper end
24 Stepped protrusion
25 Outer leg portion
26, 26a, 26b Outer division gap
27, 27a, 27b Inner division gap
4 First wire
40 First wire wound portion
41a, 41b Lead portion
5 Second wire
50 Second wire wound portion
51a, 51b Lead portion
8 Case
80 Bottom plate
81 Side plate
82 Heat dissipation resin
82a Atmosphere open surface
9 Partial adhesive portion
9a Adhesive portion
10 Air layer

What is claimed is:

1. A coil device comprising:
a core including a magnetic material; and
a wire disposed in a coil shape around at least a part of the core, wherein the core includes:
a middle leg portion on which a wound portion of the wire is disposed,
an outer leg portion disposed outside the wound portion of the wire, and
a base portion magnetically connecting the middle leg portion and the outer leg portion,
70% or more of a volume of the middle leg portion is located below an atmosphere open surface of a heat dissipation resin,
an outer division gap is provided in a middle or an end portion of the outer leg portion,
the outer division gap includes a partial adhesive portion in which an adhesive is interposed and an air layer in which an adhesive is not interposed, and
the air layer is located below the atmosphere open surface of the heat dissipation resin.

2. The coil device according to claim 1, wherein
the outer leg portion has a first outer leg portion and a second outer leg portion, and
the outer division gap is provided between a distal end of the first outer leg portion and a distal end of the second outer leg portion.

3. The coil device according to claim 1, wherein the outer division gap is provided between one end of the outer leg portion and an inner surface of the base portion.

4. The coil device according to claim 1, wherein an area proportion of the partial adhesive portion in a cross-section of the outer division gap is 3% or more and 50% or less.

5. A coil device comprising:
a core including a magnetic material; and
a wire disposed in a coil shape around at least a part of the core, wherein the core includes:
a middle leg portion on which a wound portion of the wire is disposed,
an outer leg portion disposed outside the wound portion of the wire, and
a base portion magnetically connecting the middle leg portion and the outer leg portion,
70% or more of a volume of the middle leg portion is located below an atmosphere open surface of a heat dissipation resin,
an inner division gap is provided in a middle or an end portion of the middle leg portion,
the inner division gap includes an adhesive portion at least partially filled with an adhesive,
an outer division gap is provided in a middle or an end portion of the outer leg portion,
an air layer is provided in the outer division gap, and
the adhesive portion and the air layer are located below the atmosphere open surface of the heat dissipation resin.

6. The coil device according to claim 5, wherein
the middle leg portion has a first middle leg portion and a second middle leg portion, and
the inner division gap is provided between a distal end of the first middle leg portion and a distal end of the second middle leg portion.

7. The coil device according to claim 5, wherein the inner division gap is provided between one end of the middle leg portion and an inner surface of the base portion.

8. The coil device according to claim 1, wherein a gap width of the outer division gap is a thickness that does not allow the heat dissipation resin existing around the outer division gap to enter.

9. The coil device according to claim 8, wherein the gap width is 50 μm or less.

10. The coil device according to claim 1, wherein the base portion is close to a cooling wall surface of a case filled with the heat dissipation resin.

11. The coil device according to claim 1, wherein the heat dissipation resin is disposed at a position covering the wound portion of the wire disposed around the middle leg portion.

12. The coil device according to claim 1, further comprising a terminal block holding a lead portion of the wire.

13. The coil device according to claim 12, wherein the terminal block is mounted to a bobbin, a case accommodating the heat dissipation resin, or the core.
